(19) United States
(12) Patent Application Publication
(10) Pub. No.: US 2007/0177029 A1
(43) Pub. Date: Aug. 2, 2007

(54) Color correction apparatus

(75) Inventors: Toru Wada, Saitama (JP); Masaya Katsumata, Kanagawa (JP); Yasuhiro Komiya, Tokyo (JP); Osamu Konno, Saitama (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/698,336

(22) Filed: Jan. 26, 2007

(30) Foreign Application Priority Data
Jan. 31, 2006 (JP) 2006-022370

(51) Int. Cl. H04N 5/228

(52) U.S. Cl. 348/222.1

(57) ABSTRACT

An object is to carry out color correction in a highly accurate manner on images acquired by various digital cameras and scanners. A color correction apparatus includes a determining unit configured to determine whether or not preprocessing for removing the effect of previously-performed color correction is required for a reference image that is used for a reference of color correction and a color correction target image on which color correction is to be carried out; a preprocessing unit configured to carry out preprocessing on a reference image and a color correction target image that is determined by the determining unit as requiring preprocessing and output a preprocessed image; a color-correction processing unit configured to acquire a reference image or color correction target image that is not preprocessed if the determining unit determines that the reference image or color correction target image does not require preprocessing or to acquire a preprocessed reference image or color correction target image if the determining unit determines that the reference image or color correction target image requires preprocessing, and to correct the color correction target image on the basis of the acquired reference image.

### BACKGROUND OF THE INVENTION

1. Field of the Invention

The present invention relates to a color correction apparatus, a color correction method, and a color correction program that carry out color correction of an input image.

This application is based on Japanese Patent Application No. 2006-022370, the content of which is incorporated herein by reference.

2. Description of Related Art

Low-priced high-pixel-number digital cameras have been developed and have been used in a wide range of fields. Digital cameras are advantageous in that an image can be confirmed immediately after it is captured. However, there are problems in that the color of an image changes every time an image of the same object is captured because the accuracy of color correction carried out on a captured image is low.

Therefore, various technologies for digital cameras to improve the accuracy of color correction of an image have been proposed.

For example, Japanese Unexamined Patent Application, Publication No. 2005-341175 discloses a technology for improving the accuracy of color correction by installing a color detection unit configured to detect color information (e.g., spectrum) of an object in a digital camera to be used to photograph an object and carrying out color correction of an image acquired by the digital camera on the basis of the color information acquired by the color detection unit.

However, according to the invention disclosed in Japanese Unexamined Patent Application, Publication No. 2005-341175, the image to be color-corrected is limited to an image that has been captured by a digital camera having color detection unit; thus this approach lacks versatility.

### BRIEF SUMMARY OF THE INVENTION

An object of the present invention is to provide a color correction apparatus, a color correction method, and a color correction program that enable color correction to be carried out in a highly accurate manner on images acquired by various digital cameras and scanners.

According to a first aspect of the present invention, a color correction apparatus includes a determining unit configured to determine whether or not preprocessing for removing the effect of previously-performed color adjustment is required for a reference image that is used as a reference of color adjustment and a color correction target image on which color correction is to be carried out; a preprocessing unit configured to carry out preprocessing on the reference image and color correction target image that are determined by the determining unit as requiring preprocessing and to output preprocessed images; and a color-correction processing unit configured to acquire a reference image or color correction target image that is not preprocessed if the determining unit determines that the reference image or color correction target image does not require preprocessing or to acquire a preprocessed reference image or color correction target image if the determining unit determines that the reference image or color correction target image requires preprocessing, and to correct the color correction target image on the basis of the acquired reference image.

According to such a structure, when the determining unit determines that preprocessing is required for the reference image and the color correction target image, after preprocessing is carried out by the preprocessing unit, the reference image and the color correction target image are sent to the color-correction processing unit.

In such a case, if the preprocessing unit carries out preprocessing for removing the effect of previously-performed color correction on the reference image and the color correction target image that have been determined as requiring preprocessing by the determining unit, it is possible to return the images to images in an estimated state before color correction was carried out. In this way, it becomes possible to carry out color correction in a highly accurate manner using the reference image and color correction target image that are not color-corrected. Thus, the colors displayed on a CRT monitor and liquid crystal monitor become closer to the actual colors, and a wide variety of image-acquisition apparatuses may be employed, without being limited by the image-acquisition apparatus used for acquiring the color correction target image.

In the above-described color correction apparatus, the preprocessing may include gradation restoration for restoring the effect of gradation correction that has been previously performed on an input reference image or color correction target image.

In general, the difference in brightness (difference between brightness and darkness), i.e., the dynamic range, of output devices, such as CRT monitors and liquid crystal monitors, is extremely small compared to that of the natural environment. Therefore, when an image acquired by an image-acquisition apparatus, such as a digital camera, is directly displayed, the difference between brightness and darkness in the image will be small, and the image will not give a strong impression. Accordingly, with an image-acquisition apparatus, such as a digital camera, when creating image data, gradation correction using the characteristic represented by the S-shape shown in FIG. 6 is often carried out so as to enhance the brightness and darkness and increase the contrast between the darkness and brightness of the image. This gradation correction is known as “S-curve correction”, from the S-shaped curve representing the characteristic, as shown in FIG. 6.

As is apparent from the relationship between input and output shown in FIG. 6, when the input is near zero and near the maximum value, the output has low sensitivity (i.e., the amount of increase is reduced), whereas when the input is in the intermediate area, the graph is a straight line or a substantially straight curved line. In this way, the input signal values near the minimum value and near the maximum value are set so as to have smaller difference values, whereas the input signal values near the intermediate area are set to have large difference values. In this way, an image having a good contrast between darkness and brightness is acquired. The curvature of the S-shaped curve can be set or edited in any way, such as the examples represented by the solid line and dotted lines in the drawing, by an image-acquisition apparatus, such as a digital camera, or an editing apparatus configured to edit image data created by the image-acquisition apparatus.

As described above, S-curve correction using specific parameters employed by each individual image-acquisition apparatus is already performed on the RGB signal values of an image that is acquired by an image-acquisition apparatus and that is input to the color correction apparatus.

According to this aspect, by performing gradation restoration as preprocessing on an input image so as to restore the effect of gradation correction previously performed on the input image by the preprocessing unit, the reference image and the color correction target image are returned to a state before color correction was carried out. Thus, the image-acquisition apparatus used for acquiring the color correction target image is not limited, and color correction can be carried out in a highly accurate manner.

According to the above-described color correction apparatus, the preprocessing may include γ-correction for restoring the effect of inverse γ-correction that has been previously performed on an input reference image or color correction target image.

Here, γ-correction is a type of correction carried out in advance on image data in accordance with the light-generating characteristic of an output device, such as a CRT monitor, when the image data is created. For example, a CRT monitor is known to have a non-linear input/output characteristic, as shown in FIG. 7. This characteristic can be represented by Equation 1 below:

So=Si^{γ} (1)

In Equation 1, So represents an output signal, Si represents an input signal, and γ represents a value set in accordance with the characteristic of the output device.

In this way, since the relationship between the input and output for a CRT monitor is non-linear, an image-acquisition apparatus, such as a digital camera, carries out processing in which the pixel values are multiplied by 1/γ, which is the reciprocal of γ (hereinafter, this processing is referred to as “inverse γ processing”), so as to make adjustments to obtain a display with a linear input/output characteristic

The above-mentioned value of γ differs depending on the type of the output device. For example, if the output device is a monitor for a personal computer, the standard value is set to γ=2.2 or γ=1.8, depending on the operating system (OS).

According to this aspect, the preprocessing unit carries out γ-correction as preprocessing on the input images so as to restore the effect of inverse γ-correction previously carried out on the input images. In this way, the reference image and the color correction target image returns to the state before the inverse γ-correction was carried out on the images. Thus, the image-acquisition apparatus used to acquire the color correction target image is not limited, and color correction can be carried out in a highly accurate manner.

The above-described color correction apparatus may further include an input unit configured to receive an input from an external unit based on whether or not the preprocessing is required, wherein the determining unit carries out a determination process on the basis of information from the input unit.

In this way, it is possible to determine whether or not preprocessing is required on the basis of information input by the user, and the determination process can be carried out in a highly accurate manner.

According to the above-described color correction apparatus, the determining unit may carry out a determination process on the basis of at least one of a file name and attribute information of the reference image and color correction target image.

In this way, by carrying out a determination process based on the file name or attribute information of the reference image and the color correction target image, whether or not preprocessing is required can be determined automatically without an instruction from the user.

In the above-described color correction, the reference image may comprise spectral image data corresponding to more than four spectral bands.

By using spectral image data of more than four spectral bands as a reference image, the accuracy of color correction can be improved.

In the above-described color correction apparatus, the preprocessing unit may include an estimating unit configured to estimate the type of the input apparatus used for inputting the reference image or the color correction target image, a storage unit configured to store, in association with the input apparatus, parameters used for the preprocessing, a parameter-acquiring unit configured to acquire parameters corresponding to the input apparatus estimated by the estimating unit, and a processing unit configured to carry out the preprocessing on the input reference image or color correction target image using the parameters acquired by the parameter-acquiring unit.

According to such a structure, the input device used for acquiring the reference image or the color correction target image is estimated by the estimating unit, and parameters linked to the estimated input device are acquired from the storage unit by the parameter-acquiring unit. The parameters are sent to the preprocessing unit that carries out preprocessing, and preprocessing using these parameters is carried out by the preprocessing unit. In this way, since the storage unit stores parameters for color correction specific to each input device, preprocessing using parameters corresponding to the input device can be easily carried out.

The input device is, for example, an image-acquisition apparatus, such as a digital camera that acquires an image of an object and outputs the image after editing or a scanner that digitizes a photograph taken using a silver halide camera and outputs the digitized data. The estimating unit estimates, for example, what type of digital camera has been used to acquire and create a reference image and a color correction target image or what type of scanner has been used to digitize an image.

The above-described color correction apparatus may further include a reference-image storage unit configured to store a plurality of reference images; a reference-image selecting unit configured to select a reference image that satisfies a predetermined condition from the reference-image storage unit; and a reference-image acquiring unit configured to acquire a reference image selected by the reference-image selecting unit from the reference-image storage unit, and the color-correction processing unit may correct the color correction target image using a reference image acquired by the reference-image acquiring unit.

According to such a structure, since the reference-image storage unit that stores a plurality of image data sets corresponding to reference images may acquire images of various objects in advance, many reference images can be stored in the reference-image storage unit. Since a suitable reference image is automatically acquired by the reference-image acquiring unit for color correction, the user does not have to carry out operations such as specifying a reference image, and thus, color correction can be carried out extremely easily.

According to the above-described color correction apparatus, the reference-image storage unit may be provided on a file server connected via a network.

By providing the reference-image storage unit that stores reference images on a network in this way, many reference images can be stored, and the size of the color correction apparatus can be reduced. Furthermore, by employing a structure in which the reference-image storage unit can be accessed by a plurality of color correction apparatuses, the user does not have to acquire a reference image by himself or herself. As a result, the burden placed on the user is reduced, and convenience of the apparatus is improved.

The above-described color correction apparatus may further include a color-correction-target-image analyzing unit configured to analyze the color correction target image, wherein the reference-image selecting unit may select a reference image in accordance with the analysis result of the color-correction-target-image analyzing unit.

According to such a structure, since the reference image is automatically selected, the burden place on the user can be reduced.

The above-described color correction apparatus may further include an image-acquisition information input unit configured to input information related to at least one of an object and an image-acquisition condition of the color correction target image, and the reference-image selecting unit may select a reference image in accordance with the information input from the image-acquisition information input unit.

According to such a structure, since the reference image is searched for among object names and image-acquisition sites, a suitable reference image can be acquired with high probability.

The above-described color correction apparatus may further include a candidate-presenting unit configured to present a plurality of reference images selected by the reference-image selecting unit to the user as reference image candidates; and a reference-image determining unit configured to select a reference image to be actually used from the reference image candidates presented by the candidate-presenting unit, wherein the plurality of reference images is selected by the reference-image selecting unit as reference images.

According to such a structure, a reference image to be used can be easily selected from many reference images with high probability.

According to a second aspect of the present invention, a method of color correction includes a determining step of determining whether or not preprocessing for removing the effect of previously-performed color adjustment is required for a reference image that is used as a reference of color adjustment and a color correction target image on which color correction is to be carried out; a preprocessing step of carrying out preprocessing on the reference image and color correction target image that are determined as requiring preprocessing and outputting preprocessed images; and a color correction step of acquiring a reference image or color correction target image that is not preprocessed if the determining unit determines that the reference image or color correction target image does not require preprocessing or acquiring a preprocessed reference image or color correction target image if the determining unit determines that the reference image or color correction target image requires preprocessing, and correcting the color correction target image on the basis of the acquired reference image.

The above-described method of color correction may further include a reference-image storing step of storing a plurality of reference images; a reference-image selecting step of selecting a reference image that satisfies a predetermined condition from the plurality of reference images stored in the reference-image storing step; and a reference-image acquiring step of acquiring the selected reference image, wherein, in the color correction step, the color correction target image may be corrected using the reference image acquired in the reference-image acquiring step, and, in the reference-image acquiring step, the reference image may be acquired via a network.

According to such a method, since the reference-image storing step of storing a plurality of image data sets corresponding to reference images is provided, many reference image can be stored by acquiring images of various objects in advance. Since a suitable reference image is automatically acquired for color correction in the reference-image acquiring step, the user does not have to specify a reference image, and thus, color correction can be carried out extremely easily.

According to a third aspect of the present invention, a color correction program to be executed by a computer includes a determining step of determining whether or not preprocessing for removing the effect of previously-performed color adjustment is required for a reference image that is used as a reference of color adjustment and a color correction target image on which color correction is to be carried out; a preprocessing step of carrying out preprocessing on the reference image and color correction target image that are determined as requiring preprocessing and outputting preprocessed images; and a color correction step of acquiring a reference image or color correction target image that is not preprocessed if the determining unit determines that the reference image or color correction target image does not require preprocessing or acquiring a preprocessed reference image or color correction target image if the determining unit determines that the reference image or color correction target image requires preprocessing, and correcting the color correction target image on the basis of the acquired reference image.

The above-described color correction program may further include a reference-image storing step of storing a plurality of reference images; a reference-image selecting step of selecting a reference image that satisfies a predetermined condition from the plurality of reference images stored in the reference-image storing step; and a reference-image acquiring step of acquiring the selected reference image, wherein, in the color correction step, the color correction target image may be corrected using the reference image acquired in the reference-image acquiring step, and, in the reference-image acquiring step, the reference image may be acquired via a network.

When a computer executes such a program, many reference images can be stored in advance. Since a suitable reference image is acquired for color correction in the reference-image acquiring step, the user does not have to specify a reference image, and thus, color correction can be carried out extremely easily.

The present invention is advantageous in that color correction can be carried out in a highly accurate manner on images acquired by various types of digital cameras and scanners.

### BRIEF DESCRIPTION OF THE SEVERAL VIEWS OF THE DRAWINGS

FIG. 1 is a block diagram of the overall structure of a color correction apparatus according to an embodiment of the present invention.

FIG. 2 is a block diagram of the overall structure of a preprocessing unit illustrated in FIG. 1.

FIG. 3 is a block diagram of the overall structure of a color-correction processing unit illustrated in FIG. 1.

FIG. 4 illustrates an example of an image to be color-corrected.

FIG. 5 illustrates an example reference image.

FIG. 6 illustrates a γ-correction characteristic.

FIG. 7 illustrates an S-curve characteristic used for gradation correction.

FIG. 8 illustrates the overall structure of a multi-spectral camera and a cradle according to an embodiment of the present invention.

FIG. 9 illustrates the spectrum of a light source illustrated in FIG. 8.

FIG. 10 is a flow chart illustrating an example process executed by software so as to carry out a color correction method in a color correction apparatus according to an embodiment of the present invention.

### DETAILED DESCRIPTION OF THE INVENTION

Embodiments of a color correction apparatus according to the present invention will be described below with reference to the drawings.

First, before describing a color correction apparatus according to an embodiment of the present invention, a multi-spectral camera configured to acquire a reference image that is used as a reference for color correction carried out by the color correction apparatus will be described with reference to the drawings. A multi-spectral camera is a camera that is capable of spectroscopic measurements.

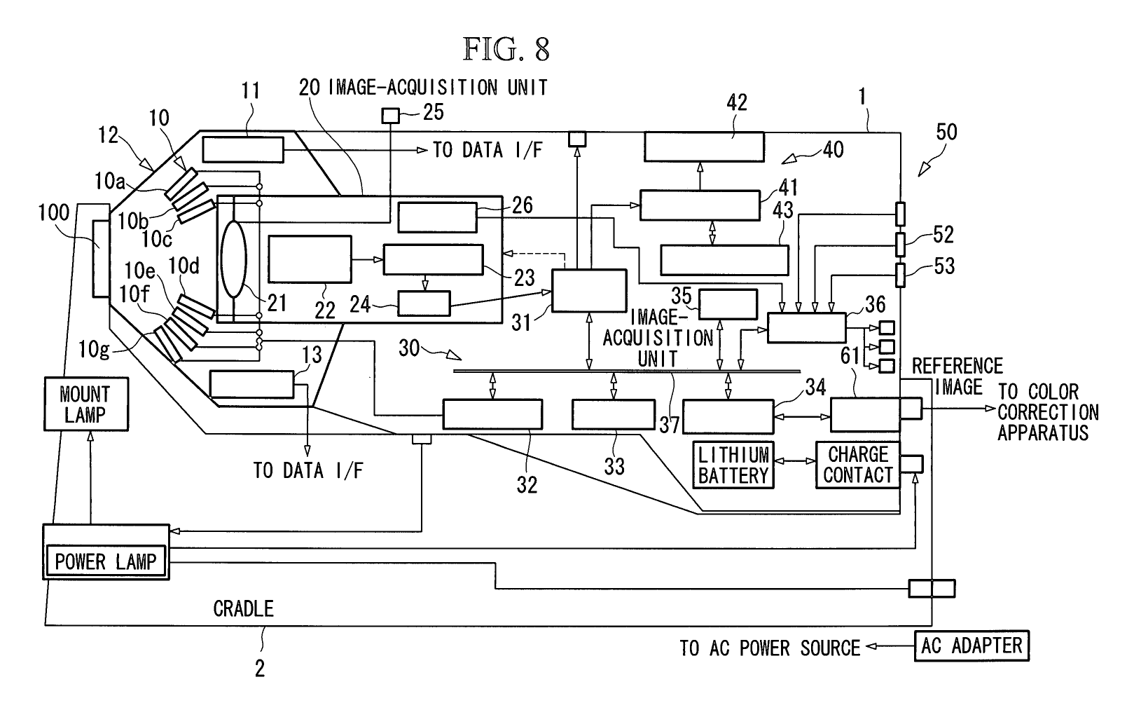

As illustrated in FIG. 8, the main components of a multi-spectral camera 1 include a light source 10, an image-acquiring unit 20, an image-acquisition control unit 30, a display unit 40, and an operation unit 50.

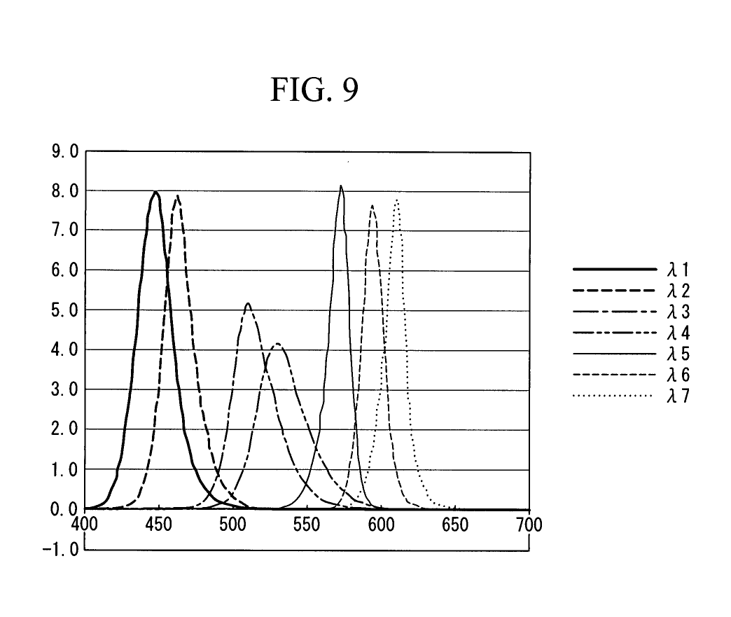

The light source 10 is disposed close to the tip of the multi-spectral camera 1 and emits illumination light for illuminating an object. The light source 10 is provided with seven light sources 10a to 10g which emit light in different wavelength bands. Each light source 10a to 10g includes four light emitting diodes (LEDs). As shown in FIG. 9, the central wavelengths of the light sources 10a to 10g are as follows: the light source 10a, about 450 nm; the light source 10b, about 465 nm; the light source 10c, about 505 nm; the light source 10d, about 525 nm; the light source 10e, about 575 nm; the light source 10f, about 605 nm; and the light source 10g, about 630 nm.

These light sources 10a to 10g are disposed, for example, in the form of a ring. Their arrangement is not particularly limited; for example, the four LEDs may be arranged in decreasing order of wavelength, in reverse order, or randomly. In addition to all of the LEDs being disposed so as to form a single ring, they may be disposed so that the LEDs are divided into a plurality of groups, each group forming one ring. The configuration of the LEDs is not limited to the ring shape described above; it is possible to employ any configuration, such as a cross-shaped arrangement, a rectangular arrangement, or a random arrangement, so long as they do not obstruct image acquisition by the image-acquiring unit 20, which is described later. The light emitting elements of the light source 10 are not limited to LEDs; for example, it is possible to use another type of light emitting element or a semiconductor laser such as a laser diode (LD).

In the multi-spectral camera 1, an illumination optical system (not shown) for radiating the illumination light from the light source 10 substantially uniformly over the surface of the object is provided at the object side of the light source 10. A temperature sensor 13 for detecting the temperature of the LEDs is provided in the vicinity of the light source 10.

The image-acquiring unit 20 is formed of an image-pickup lens 21, an RGB color image-acquisition device 22, a signal processor 23, and an analog-to-digital (A/D) converter 24. The image-pickup lens 21 forms an image of the object illuminated by the light source 10. The RGB color image-acquisition device 22 acquires an image of the object which is imaged by the image-pickup lens 21 and outputs an image signal. The RGB color image-acquisition device 22 is formed, for example, of a CCD, and its sensor responsivity substantially covers a wide visible region of the spectrum. The CCD may be a monochrome or color device. The RGB color image-acquisition device 22 is not limited to a CCD; it is possible to use other types of devices, such as CMOS image sensors.

The signal processor 23 subjects the analog signal output from the RGB image-acquisition device 22 to gain correction, offset correction, and so on. The A/D converter 24 converts the analog signal output from the signal processor 23 into a digital signal. A focus lever 25 for adjusting the focus is connected to the image-pickup lens 21. This focus lever 25 is used to manually adjust the focus, and a position detector 26 for detecting the position of the focus lever 25 is provided.

The image-acquisition control unit 30 is formed of a CPU 31, an LED driver 32, a data interface 33, a communication-interface controller 34, an image memory 35, and an operating-unit interface 36. These components are each connected to a local bus 37 and are configured to enable transmission and reception of data via the local bus 37.

The CPU 31 controls the image-acquiring unit 20, records a spectral image of the object acquired and processed by the image-acquiring unit 20 in the image memory 35 via the local bus 37, and outputs the image to an LCD controller 41, which is described later. The LED driver 32 controls the light emission of each LED provided in the light source 10. The data interface 33 receives the contents of the LED memory 11 and information from the temperature sensor 13, which are provided at the light source 10. The communication-interface controller 34 is connected to a communication-interface contact point 61, which is used for external connection, and has a function for performing communication via a USB 2.0 connection, for example. The operating-unit interface 36 is connected to various operating buttons provided on the operating unit 50, which is described later, and functions as an interface for forwarding instructions input via the operating unit 50 to the CPU 31 via the local bus 37. The image memory 35 stores image data acquired in the image-acquiring unit 20.

The display unit 40 is formed of the LCD controller 41 and a liquid crystal display (LCD) 42. The LCD controller 41 displays on the LCD 42 an image based on the image signal sent from the CPU 31, for example, the image currently being acquired by the image-acquiring unit 20 or a previously acquired image. As required, an image pattern stored in an overlay memory 43 may be superimposed on the image obtained from the CPU 31 and displayed on the LCD 42. The image pattern stored in the overlay memory 43 is, for example, a horizontal line for acquiring an image of an entire tooth horizontally, a intersecting line perpendicular thereto, an image-acquisition mode, an identification number of the acquired tooth, and so forth.

The operating unit 50 is provided with various operating switches and operating buttons for the user to input an instruction to commence spectral image acquisition and an instruction to commence or terminate moving-image acquisition. More specifically, the operating unit 50 includes a shutter button 52 and a viewer control button 53, which is a switch for changing the image displayed on the LCD 42.

The cradle 2 supporting the multi-spectral camera 1 includes a color chart 100 for calibrating the image-acquiring unit 20.

The multi-spectral camera 1 having the above-described structure carries out multiband image-acquisition in which illumination light beams of seven wavelength bands (illumination light beams of seven colors) are sequentially radiated onto the object and seven spectral images of the object are acquired as still images.

### Multiband Image Acquisition

Next, a process of acquiring a multiband image that is used as a reference image will be described in detail.

First, the multispectral camera is lifted from the cradle 2 by the user, and a contact cap is attached to a mounting hole (not shown) provided at light-emitting side of the multispectral camera case. This contact cap is made of a flexible material and has a substantially cylindrical shape.

Then, the image-acquisition mode is set to a “colorimetry mode” by the user, whereupon the object is displayed as a moving image on the LCD 42. While looking at the image displayed on the LCD 42, the user disposes the object at a suitable position in the image-acquisition area and adjusts the focus using the focus lever 25. The contact cap is formed in a shape which guides the object to a suitable image-acquisition position, and therefore, it is possible to easily carry out this positioning. The contact cap blocks outside light, enabling image acquisition under darkness.

Once positioning and focus adjustment have been completed, the user presses the shutter button 52, whereupon a signal to that effect is sent to the CPU 31 via the operating unit interface 36, and multiband image-acquisition is executed under the control of the CPU 31.

In multiband image acquisition, by sequentially driving the light sources 10a to 10g with the LED driver 32, LED radiation light of different wavelength bands is sequentially radiated onto the object. The reflected light from the object forms an image on the surface of the RGB image-acquisition device 22 in the image-acquiring unit 20, and is acquired as an RGB image.

The acquired RGB image is sent to the signal processor 23. The signal processor 23 subjects the input RGB image signal to predetermined image processing and, from the RGB image signal, selects image data of one predetermined color in response to the wavelength bands of the light sources 10a to 10g. More specifically, the signal processor 23 selects the B image data from the image signal corresponding to the light sources 10a and 10b, selects the G image data from the image signal corresponding to the light sources 10c to 10e, and selects the R image data from the image signal corresponding to the light sources 10f and 10g. Therefore, the image-processing unit 23 selects image data of wavelengths which substantially match the central wavelengths of the illumination light.

The image data selected by the signal processor 23 is sent to the A/D converter 24 and is stored in the image memory 35 via the CPU 31. As a result, the color images selected from the RGB images corresponding to the central wavelengths of the LED are stored in the image memory 35 as multiband images. During image acquisition, the LED radiation time and radiation intensity, the electronic shutter speed of the image-acquisition element, and so forth are controlled by the CPU 31 so that image acquisition of the respective wavelengths is performed with the proper exposure; if there is a substantial temperature change during image acquisition, the alarm buzzer 65 emits an audible alarm.

Another image of the object is acquired without illuminating the LEDs and is stored in the image memory 35 as an external-light image.

Next, once image acquisition has been completed and the multi-spectral camera 1 is placed in the cradle 2 by the user, measurement of a reference plate image is performed.

Measurement of the reference plate image is performed for acquiring an image of the color chart 100 using the same procedure as that used for the acquiring an image of the object. The acquired image is stored in the image memory 35 as a reference plate image.

Next, the multiband image is subjected to signal correction using the above-described dark image and reference plate image stored in the image memory 35. By subtracting the dark image, dark-current correction of the CCD can be carried out, and the effect of external light during image acquisition can be eliminated.

Since a multiband image cannot be displayed in correct colors without being processed, conversion to RGB signals must be carried out for display or when used as a reference image. Thus, by processing the signal values of each band on the basis of the reference plate image data, the spectral reflectance of the object is estimated, and RGB signals that represent accurate colors and that are reconstructed under a predetermined observation light source are obtained by conversion. In general, this step is automatically carried out during the time period from reading out the multiband image to displaying the multiband image.

After signal correction is carried out in this way, the multiband image is transferred to a color correction apparatus, described below, via a local bus 37, a communication-interface controller 34, and a communication-interface contact point 61 and is stored inside the color correction apparatus.

Next, a color correction apparatus according to an embodiment of the present invention will be described with reference to the drawings.

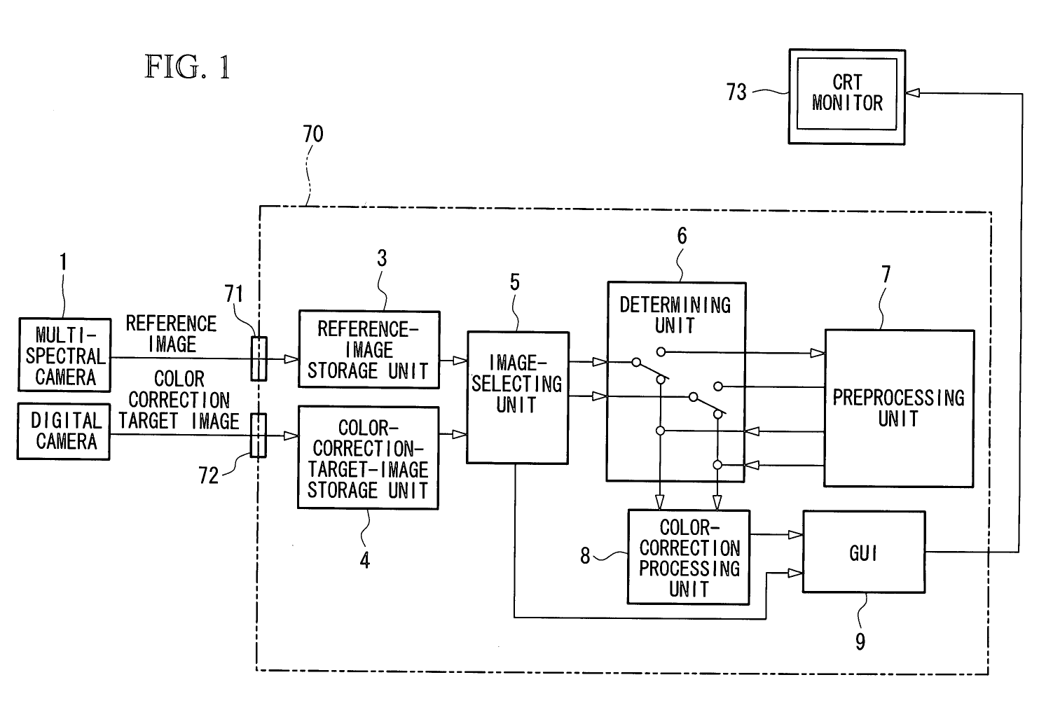

FIG. 1 is schematic view of the structure of the color correction apparatus according to an embodiment of the present invention.

As shown in FIG. 1, a color correction apparatus 70 includes a reference-image storage unit 3, a color-correction-target-image storage unit 4, an image-selecting unit 5, a determining unit 6, a preprocessing unit 7, a color-correction processing unit 8, and a graphical user interface (GUI) 9.

The color correction apparatus 70 mainly includes an interface 71 that transmits data to and from the multi-spectral camera 1 and an interface 72 that transmits data to and from a digital camera used for inputting a color correction target image. A plurality of interfaces 71 and 72 may be provided, or, instead, a single interface may be used as both the interfaces 71 and 72.

As shown in FIG. 1, the reference-image storage unit 3 stores a multiband image that has been acquired using the above-described multi-spectral camera 1 as a reference image.

The color-correction-target-image storage unit 4 stores an RGB color image that is to be color-corrected as a color correction target image. The color correction target image is, for example, an image acquired by an image-acquisition apparatus, such as a digital camera, or an image acquired by digitizing an image acquired by a silver halide camera using a scanner. In the descriptions below, an apparatus for inputting a color correction target image to the color correction apparatus 70, such as the above-described digital camera and scanner, is referred to as an “input apparatus”.

A file name is assigned to each color correction target image stored in the color-correction-target-image storage unit 4, allowing the color correction target images to be identified. Attribute information representing attributes of the input apparatus used to input the image is linked to each of the reference images and color correction target images. For example, if the color correction target image is acquired using a digital camera and is input to the color correction apparatus 70, information that specifies the digital camera, e.g., the model of the digital camera, is linked to the color correction target image as attribute information. When the reference image is acquired using the multi-spectral camera 1, identification information that identifies the multi-spectral camera 1 is linked to the reference image as attribute information.

The attribute information may be written in the header of the image file or, instead, may be included as part of the file name. The date of acquisition or date of creation of the image is added to each of the reference images and color correction target images.

The image-selecting unit 5 acquires a color correction target image that is to be color-corrected from the reference-image storage unit 3 on the basis of an instruction from the user, acquires a reference image corresponding to this color correction target image from the reference-image storage unit 3, and outputs the reference image to the determining unit 6. For example, the GUI 9 displays a screen for selecting the reference image and color correction target image on a CRT monitor 73. Information on the images selected on the display screen is output to the image-selecting unit 5. The image-selecting unit 5 acquires a predetermined reference image and a color correction target image from the reference-image storage unit 3 and the color-correction-target-image storage unit 4, respectively, on the basis of the information acquired from the GUI 9 and outputs this information to the determining unit 6. The reference image must include an object that is the same as the object in the color correction target image.

The determining unit 6 determines whether or not preprocessing is required on the reference image and the color correction target image from the image-selecting unit 5. This determination process is carried out by referring to the attribute information added to the images. For example, the determining unit 6 stores a list of attribute information of images requiring preprocessing. By checking the attribute information of an image against this list, it is determined whether or not preprocessing is required. As a result, images determined as requiring preprocessing are output to the preprocessing unit 7, whereas images determined as not requiring preprocessing are output to the color-correction processing unit 8.

The preprocessing unit 7 carries out preprocessing on an image from the determining unit 6 that is determined as requiring preprocessing and then outputs the preprocessed image to the color-correction processing unit 8 via the determining unit 6. Here, “preprocessing” refers to a process of canceling out the effects of color adjustment that has been performed on an image input sent from the determining unit 6 so as to return the image to the state before color adjustment was carried out. For example, with a digital camera, to display a clearer image, in general, various types of color adjustment, such as white balance adjustment, gradation correction, color enhancement, and edge enhancement, are carried out on the RGB signals acquired using a CCD camera or the like. Furthermore, in general, inverse γ correction corresponding to the input/output signal characteristic of a display device (e.g., CRT monitor or liquid crystal monitor) for displaying an image is carried out.

As described above, characteristics used for color adjustment (white balance adjustment, gradation correction, color enhancement, edge enhancement, and inverse γ correction) differ depending on the model of the digital camera, and characteristic values corresponding to the model are employed. The color adjustment process to be carried out also differs depending on the model of the digital camera.

Therefore, the preprocessing unit 7 estimates what kind of color adjustment has been carried out on the image sent from the determining unit 6 and carries out inverse color adjustment so as to cancel out the effect of the estimated color adjustment. By canceling out the effect of inverse color adjustment, the image can be returned to the image before color adjustment was carried out.

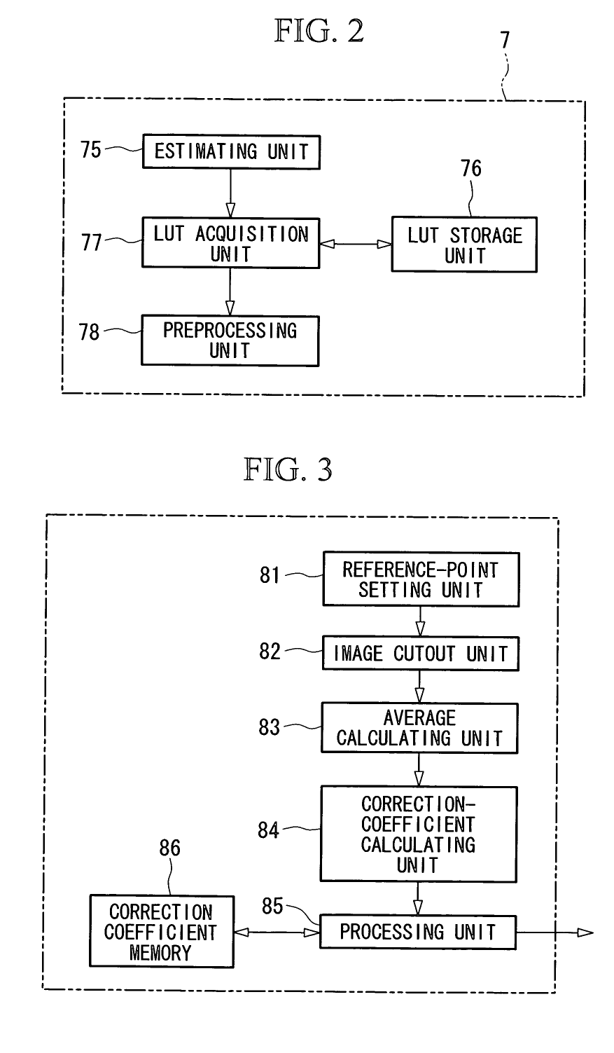

For carrying out preprocessing, such as that described above, the preprocessing unit 7, for example, has the structure illustrated in FIG. 2.

In FIG. 2, the preprocessing unit 7 includes an estimating unit 75 configured to estimate the model of the digital camera that has been used to acquire an image input sent from the determining unit 6, a lookup table (LUT) storage unit 76 configured to link a digital camera model and LUTs (which is an example of a parameter according to an embodiment of the present invention) for canceling out the effects of color adjustment carried out on an image acquired by the digital camera, an LUT acquiring unit 77 configured to acquire an LUT that is linked to the digital camera model estimated by the estimating unit 75 from the LUT storage unit 76, and a preprocessing unit 78 configured to carry out preprocessing (inverse color adjustment) using the LUT acquired by the LUT acquiring unit 77.

In such a preprocessing unit 7, the estimating unit 75 estimates (specifies) the model of the digital camera by, for example, referring to the attribute information linked to the image.

The LUT storage unit 76 may store one LUT for each model of digital camera or may store a plurality of LUTs for each model of digital camera. For example, for a digital camera that carries out inverse γ correction and gradation correction, an LUT for canceling out the effects of each of these processes may be provided, or, instead, one LUT for canceling out the effects of both processes at once may be provided. The characteristic of a LUT for canceling out the effects of both the inverse γ correction and the gradation correction at once will be equivalent to a characteristic obtained by adding a γ characteristic used for canceling out the effects of the inverse γ correction and an inverse gradation correction characteristic for canceling out the effects of the gradation correction.

The preprocessing unit 78 carries out preprocessing by using an LUT acquired by the LUT acquiring unit 77, corrects all pixel values in the input image, and then outputs the preprocessed image to the color-correction processing unit 8 via the determining unit 6.

When a reference image and a color correction target image are input as described above, the color-correction processing unit 8 carries out color correction of the color correction target image on the basis of the reference image and then outputs the color-corrected color correction target image.

More specifically, as shown in FIG. 3, the main components of the color-correction processing unit 8 include a reference-point setting unit 81 configured to set reference points Cxn and Cyn on the color correction target image and the reference image, an image cutout unit 82 configured to cut out an image on the basis of the reference points Cxn and Cyn, an average-calculating unit 83 configured to determine the average of the pixel values of the cutout image, a correction-coefficient calculating unit 84 configured to calculate correction coefficients K11 to K33 employed in Equation 2, described below, from the averaged pixel values, a processing unit 85 configured to carry out color correction on the entire color correction target image using the correction coefficients calculated by the correction-coefficient calculating unit 84, and a correction-coefficient memory 86 configured to store correction coefficients calculated by the correction-coefficient calculating unit 84.

In the color-correction processing unit 8, the reference-point setting unit 81 sets reference points at corresponding positions on the color correction target image and the reference image. At least three reference points are set.

$$( \begin{matrix}R \\ G \\ B\end{matrix} ) = ( \begin{matrix}K 11 K 12 K 13 \\ K 21 K 22 K 23 \\ K 31 K 32 K 33\end{matrix} ) ( \begin{matrix}{R}^{′} \\ {G}^{′} \\ {B}^{′}\end{matrix} ) \qquad ( 2 )$$

In Equation 2, R, G, and B represent the average pixel values of the reference image, and R′, G′, and B′ represent the average pixel values of the color correction target image.

The color-corrected color correction target image created by the color-correction processing unit 8 is output to the GUI 9. The GUI 9 carries out predetermined gradation processing, inverse γ correction, and so on the input color correction target image and displays the resulting image on the CRT monitor 73.

In addition to outputting an image to the GUI 9 and displaying it on the CRT monitor 73, for example, the image may be directly output to another output apparatus via an interface (not shown in the drawings). A memory (which may be a removable memory) for storing the color-corrected color correction target image may be provided in the color correction apparatus, and the image may be stored in this memory.

Next, the operation of the above-described color correction apparatus 70 according to this embodiment will be described.

First, the image-selecting unit 5 of the color correction apparatus 70 extracts a reference image and a color correction target image from the reference-image storage unit 3 and the color-correction-target-image storage unit 4, respectively, on the basis of an instruction from the user. The extracted color correction target image and reference image are sent to the determining unit 6. In this case, the image-selecting unit 5 extracts a reference image that includes the same object as that included in the color correction target image from the reference-image storage unit 3.

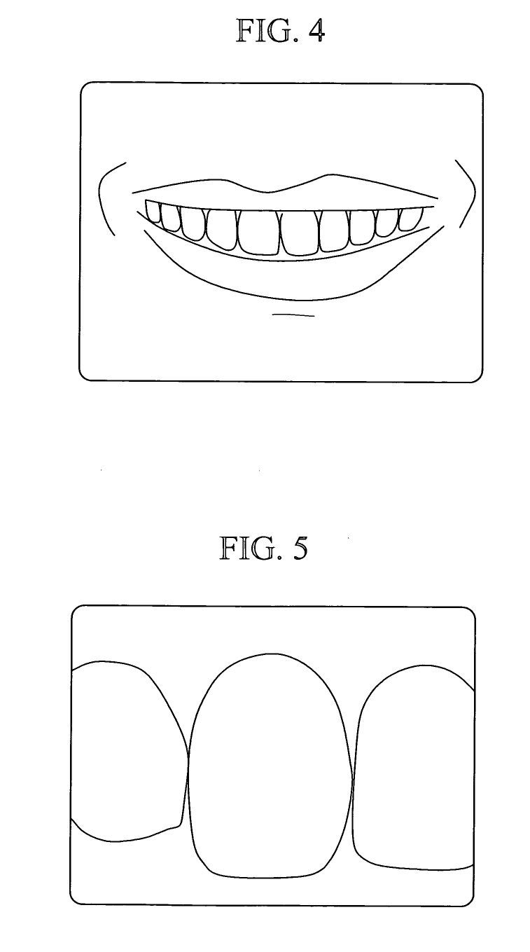

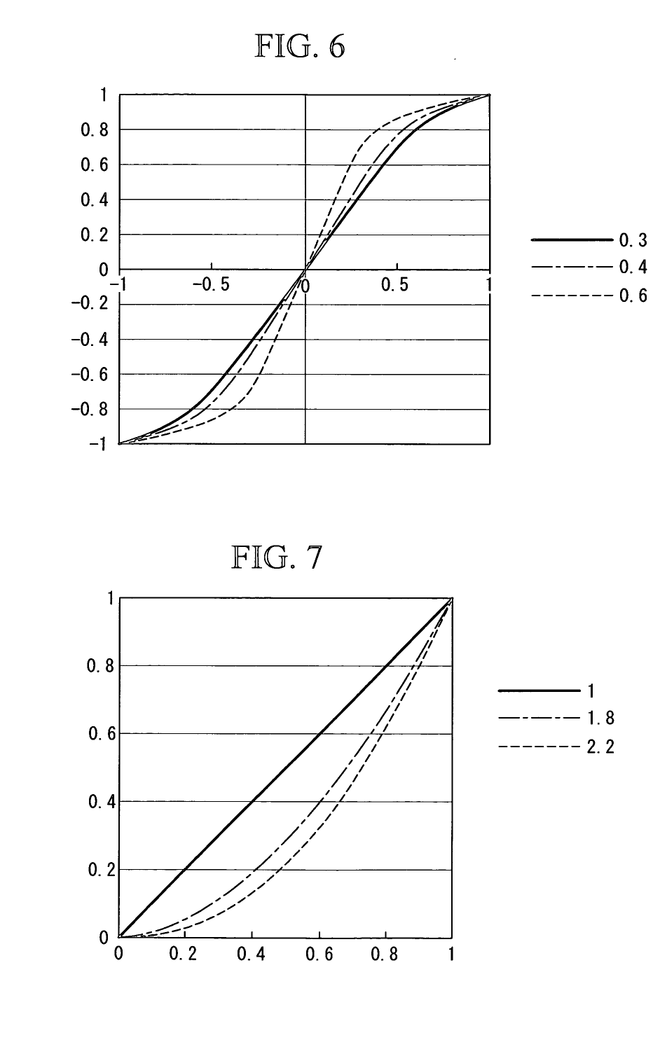

According to this embodiment, as shown in FIG. 4, a color correction target image of teeth, which are the objects being acquired, is selected, and, as shown in FIG. 5, a multiband image of the same object is selected as the reference image. The color correction target image is an RGB color image acquired using a typical digital camera. Color adjustment, such as inverse γ correction and gradation correction, is already carried out on the RGB color image. In contrast, no color adjustment is carried out on the multiband image acquired using the multi-spectral camera 1.

The determining unit 6 determines whether or not preprocessing is required by referring to the attribute information of the reference image and color correction target image. According to this embodiment, since color adjustment is not carried out on the reference image acquired using the multi-spectral camera 1, the determining unit 6 determines that preprocessing is not required. In contrast, since color adjustment is already carried out on the color correction target image acquired using a digital camera, the determining unit 6 determines that preprocessing is required. Accordingly, the color correction target image is output to the preprocessing unit 7, whereas the reference image is output to the color-correction processing unit 8.

At the preprocessing unit 7, the attribute information of the color correction target image input from the determining unit 6 is referred to by the estimating unit 75, shown in FIG. 2. As a result, the model of the input apparatus, e.g., digital camera, used to acquire the color correction target image is estimated. Subsequently, the LUT corresponding to the model of the digital camera estimated by the estimating unit 75 is acquired from the LUT storage unit 76 by the LUT acquiring unit 77, and the LUT is output to the preprocessing unit 78. The extracted LUT is used for canceling out the effects of color adjustment, such as inverse γ correction and gradation correction, carried out by the digital camera that acquired the color correction target image.

Subsequently, the preprocessing unit 78 carries out preprocessing, using the LUT acquired by the LUT acquiring unit 77, on the color correction target image. As a result, the color correction target image is returned to the state before color adjustment was carried out. In this way, the color correction target image returned to the image before color adjustment was carried out is output from the preprocessing unit 78 to the color-correction processing unit 8 via the determining unit 6, shown in FIG. 1.

After the reference image and the color correction target image are input to the color-correction processing unit 8, as described above, at least three reference points Cxn and Cyn are set on the color correction target image and the reference image by the reference-point setting unit 81 of the color-correction processing unit 8, shown in FIG. 3. Images defined by the reference points Cxn and Cyn are cut out by the image cutout unit 82. The cutout images are output to the average-calculating unit 83, and the average values of the pixel values at each reference point are calculated.

Subsequently, the correction-coefficient calculating unit 84 compares the average values of the pixel values of each of the reference points Cxn and Cyn in the color correction target image and the reference image and carries out calculation based on the above-described Equation 2 to calculate the correction coefficients K11 to K33 for each color, R, G, and B. The correction coefficients K11 to K33 calculated in the above-described manner are output to the processing unit 85. At the processing unit 85, the correction coefficients K11 to K33 input from the correction-coefficient calculating unit 84 are used to carry out color correction of all pixels in the color correction target image. Then, the color-corrected color correction target image is output. The correction coefficients K11 to K33 used at this time are stored in the correction coefficient memory 86 for future use in color correction.

For example, since the same correction coefficients may be used for an RGB color image acquired under the same conditions as the above-described color correction target image, it is possible to easily carry out color correction by omitting the process of calculating the correction coefficients.

By carrying out color adjustment processing, such as γ processing and gradation processing, on the color-corrected color correction target image output from the color-correction processing unit 8 at the GUI 9 provided downstream, the color correction target image is converted into a clearer image and is displayed on an output device, such as the CRT monitor 73.

As described above, with the color correction apparatus 70 according to this embodiment, whether or not preprocessing is required for the color correction target image and the reference image is determined by the determining unit 6. For an image that has been determined as requiring preprocessing, preprocessing is carried out by the preprocessing unit 7, and then the preprocessed image is transferred to the color-correction processing unit 8.

In this case, the preprocessing unit 7 carries out preprocessing for canceling out the effects of color adjustment carried out in advance on the image the state has been determined as requiring preprocessing by the determining unit 6. Thus, it is possible to return the image to that before color adjustment has been carried out. In this way, it is possible to carry out color correction in a highly accurate manner by using a reference image and a color correction target image that are not color-corrected. Accordingly, the color reproducibility of a CRT monitor, a liquid crystal display, and so on can be improved.

In the above-described embodiment, a case in which the image-selecting unit 5 extracts at least one of the reference image and the color correction target image from the reference-image storage unit 3 and the color-correction-target-image storage unit 4, respectively, has been described. Instead, however, the following configuration may be employed.

For example, only a color correction target image may be assigned by the user, and the extraction of a reference image suitable for the assigned color correction target image may be automatically carried out by the image-selecting unit 5. In such a case, the image-selecting unit 5 includes, for example, a color-correction-target-image analyzing unit, a reference-image selecting unit, and a reference-image acquiring unit. The color-correction-target-image analyzing unit analyzes the image assigned as a color correction target image, and acquires an analysis result including information such as the acquisition date of the color correction target image, the file name, and data about the object.

The reference-image selecting unit selects a reference image that satisfies predetermined conditions on the basis of the date information, the data about the object, and so on acquired by the analysis carried out by the color-correction-target-image analyzing unit from a plurality of reference images stored in the reference-image storage unit 3 as reference images suitable for color correction of the color correction target image. For example, the reference-image selecting unit selects a reference image that satisfies a predetermined condition from the reference-image storage unit 3. Here, the predetermined condition is “a reference image that has been acquired on the date closest to the date the color correction target image has been acquired and that includes an object that is the same as the object included in the color correction target image”. The reference-image acquiring unit reads out the reference image selected by the reference-image selecting unit and outputs it to the determining unit 6.

According to the above-described configuration, the user need not assign a reference image; instead a reference image is automatically extracted. Thus, the burden placed on the user can be reduced.

Instead of the above-described configuration, the following configuration may be employed.

For example, in the case where a plurality of reference images are selected by the above-described reference-image selecting unit, it is possible to provide a candidate-presenting unit configured to present the plurality of reference images as reference image candidates to the user by displaying these on the CRT monitor 73 and a reference-image determining unit configured to determine the reference image assigned by the user as a reference image to be used for correction. In such a case, the predetermined condition employed by the reference-image selecting unit is less strict than that described above. For example, the predetermined condition is “a reference image that has been acquired within a predetermined period of time extending from before to after the date the color correction target image was acquired and that includes an object that is the same as the object included in the color correction target image”. When a plurality of reference images is selected by the reference-image selecting unit, as described above, the candidate-presenting unit displays the plurality of reference images as reference image candidates on the CRT monitor 73. Thus, the final decision of selecting a reference image can be made by the user. In this way, the user can select a reference image from among a plurality of images displayed as reference image candidates. Thus, for example, even when a large number of reference images are stored in the reference-image storage unit 3, the user can very easily select a reference image.

According to the above-described embodiment, it is preferable that RGB color images which have been acquired under the same illumination conditions be stored in the same folder in the color-correction-target-image storage unit 4 or be linked to each other and stored in the color-correction-target-image storage unit 4. This is preferable because the same correction coefficients can be used for carrying out color correction on RGB color images acquired under the same illumination conditions, and thus, once the correction coefficients are calculated, as described above, these correction coefficients can be used to carry out color correction on other images. In this case, preprocessing is carried out on the RGB color images as described above.

According to the above-described embodiment, the determining unit 6 determines whether or not preprocessing is required on the basis of attribute information of the image. Instead, however, a preprocessing-determination input unit (input unit) that allows the user to input whether or not preprocessing is required may be provided, and whether or not preprocessing is to be carried out may be determined on the basis of a signal sent from the preprocessing-determination input unit.

According to this embodiment, the model of the input apparatus, such as a digital camera, is added as attribute information linked to the image. Instead, however, information on the model of the input apparatus may be input by the user when the image is acquired.

According to this embodiment, reference points are automatically set by the reference-point setting unit 81, shown in FIG. 3. However, by using the GUI 9, the user may define the reference points on a screen displaying the reference image and the color correction target image.

A multiband image is provided as an example of a reference image. However, other images may be used as a reference image instead of such a multiband image. For example, an image acquired using a typical digital camera may be used to generate RGB display signals of an image on the basis of the measurement results of various parts of the object included in the image measured by a spectral colorimeter.

The above-described reference image and color correction target image do not have to be acquired on close dates. For example, if the user recognizes that the color reproducibility of an object in an image acquired by a digital camera is not satisfactory, an image of the same object may be acquired using a multiband camera at a later date. Color correction of the image of the object acquired in the past can be carried out using the image acquired by the multiband camera as a reference image.

By applying this method, for example, the user may acquire images of various sites of interest using the multi-spectral camera 1 and store these images as reference images in the reference-image storage unit 3. In this way, when images of the same objects are actually acquired using a digital camera, color correction using the stored reference images can be carried out. Thus, the trouble of acquiring a reference image at that time can be avoided.

By providing the reference-image storage unit 3 on a network and storing reference images of various objects, such as scenic sites, in the reference-image storage unit 3, the user can carry out color correction of an image of a scenic site acquired by a third person without actually visiting the site.

The above-described correction process carried out by the color-correction processing unit 8 is merely an example. Other known techniques may be employed instead.

For example, one position may be selected, and a conversion process zero may be carried out on the basis of Equation 2 in which K12, K13, K21, K23, K31, and K32 are all set to. Furthermore, the conversion coefficients based on Equation 2 may be calculated after re-selecting an observation light source on the basis of color reproduction conditions of a reference image and re-calculating the RGB values to be referred to.

Next, an example in which the reference-image storage unit 3 is provided on a network will be described below. A network service provider provides the reference-image storage unit 3 on a server. The server stores a plurality of images of various sites, such as scenery and buildings at scenic sites, acquired using a multiband camera. These images are stored in a database together with information on the site name, the name of the object, and the image acquisition date. As a camera system used for acquiring these images, the above-described multi-spectral camera 1 may be used. However, the camera system is not limited thereto, and a multiband camera system such as that described in Japanese Unexamined Patent Application, Publication No. HEI 8-105799, may be employed. Japanese Unexamined Patent Application, Publication No. HEI 8-105799 discloses a multiband camera system using a rotating filter including a plurality of narrow-band optical band-pass filters.

The user stores all of the images acquired using a digital camera during a trip in the color-correction-target-image storage unit 4 via the interface 72 of the color correction apparatus 70. Subsequently, the image-selecting unit 5 reads out a desired image selected among the images stored in the color-correction-target-image storage unit 4 by the user as a color correction target image and outputs the read out image to the determining unit 6. At the same time, a reference image suitable for the color correction target image is acquired from the reference-image storage unit 3 on the server, and this reference image is output to the determining unit 6.

The automatic extraction processing of a reference image carried out by the image-selecting unit 5 will be described below.

The image-selecting unit 5 includes, for example, a color-correction-target-image analyzing unit, a reference-image selecting unit, and a reference-image acquiring unit. In such an image-selecting unit 5, the color correction target image specified in advance is analyzed by the color-correction-target-image analyzing unit, and information on keywords that can be used for a search, e.g., image-acquisition date, and information on the color and shape of the object is obtained. Subsequently, the reference-image selecting unit searches the reference-image storage unit 3 on the server in accordance with the analysis result of the color-correction-target-image analyzing unit. For example, when the reference-image selecting unit receives the image-acquisition date as a keyword and information on the color and shape of the object, a reference image that has been acquired on a date closest to the image-acquisition date and that includes an object that has the same color and shape indicated by the information is selected from the reference-image storage unit 3. Then, the reference-image acquiring unit reads out the reference image selected at the reference-image selecting unit, sends the reference image from the reference-image storage unit 3 on the server to the color correction apparatus 70, and outputs the reference image to the determining unit 6 in the color correction apparatus 70.

When a color correction target image is specified in this way, a reference image suitable for the color correction target image is automatically extracted and input to the color correction apparatus. Accordingly, it is possible to very easily carry out color correction.

Instead of automatically carrying out all of the processes related to the extraction of a reference image, as described above, instructions may be given by the user, as described below.

For example, in addition to the above-described structure, the image-selecting unit 5 includes a candidate-presenting unit and a reference-image determining unit.

In such a case, a keyword is extracted by the color-correction-target-image analyzing unit, and the reference-image storage unit 3 is searched by the reference-image selecting unit on the basis of the keyword. At this time, the reference-image selecting unit selects several images that can possibly be used as reference images. For example, when the file name, the image-acquisition date, and the characteristics of the object are specified as keywords, the reference-image selecting unit selects, from the reference-image storage unit 3, all of the reference images that satisfy a predetermined condition of “having the same file name, being acquired within a predetermined period of time extending from before to after the image-acquisition date, and including an object having the same characteristics”. Then, all of the selected reference images are read out by the reference-image acquiring unit and are sent to the color correction apparatus 70.

The candidate-presenting unit of the color correction apparatus 70 displays the plurality of reference images sent from the reference-image acquiring unit as reference image candidates on the CRT monitor 73 via the GUI 9. When the plurality of reference image candidates are displayed on the CRT monitor 73 by the candidate-presenting unit, the user can make the final decision of selecting a reference image. When the user observes the CRT monitor 73 and specifies a reference image including the same object as that included in the color correction target image, the reference-image determining unit determines the reference image candidate as the reference image and outputs the determined reference image to the determining unit 6.

The model of the camera is estimated from the attribute information of the color correction target image at the determining unit 6; characteristics required for preprocessing are acquired by the LUT acquiring unit 77; preprocessing is carried out at the preprocessing unit 78; and the preprocessed image is sent to the color-correction processing unit 8.

The color-correction processing unit 8 receives the coefficients K11 to K33 of the above-described Equation 2 used by the reference-point setting unit 81 to set the three reference points corresponding to each of the color correction target image and the reference image. Then, color correction is carried out on the basis of the coefficients.

As described above, since the image-selecting unit 5 has a function of automatically acquiring a reference image, even when many reference images are stored in the reference-image storage unit 3, a suitable reference image can be easily acquired and color correction can be carried out.

In the above, a case in which keywords are detected by the color-correction-target-image analyzing unit has been described. Instead, however, an image-acquisition-information input unit that requests the user to input keywords (for example, information on the object and image-acquisition conditions) may be provided. In such a case, information, such as the name of the object and the site where the image was acquired, is linked to each of the reference images stored in the reference-image storage unit 3, and the reference-image selecting unit searches the reference-image storage unit 3 in accordance with the conditions input from the image-acquisition-information input unit.

When the reference image candidates are displayed on the CRT monitor 73, as described above, the user may specify the color reconstruction conditions employed by the color correction process. For example, when the color reconstruction condition set as a default condition is to reconstruct typical colors under sunlight, even if it is cloudy when the user actually photographed the image, the color correction target image after color correction will appear as an image acquired in sunny weather. Therefore, a color-corrected image having different colors from the original image will be displayed on the CRT monitor 73.

In response to such a case, the illumination condition for color reconstruction may also be set by the user. As the illumination condition, for example, the user may select whether conditions such as “sunny”, “cloudy”, or “rainy”. In this way, for example, if the color reconstruction condition is set to “cloudy” when an image is photographed under cloudy weather, the color correction target image will reflect the illumination condition of the actual photographed image. In contrast, if the color reconstruction condition is set to “sunny” when an image is photographed in cloudy weather, the acquired image will appear as if it was photographed in sunny weather. In this way, images under various illuminations can be reconstructed in accordance with the user's choice.

When the reference-image storage unit 3 is provided on a file server on a network, the color-correction-target-image analyzing unit, the reference-image selecting unit, and the reference-image acquiring unit, all described above, may be provided on the file server on the network.

According to the above-described embodiment, the color correction apparatus 70 is realized by hardware. However, the structure is not limited thereto. For example, a structure in which the color correction apparatus 70 is realized by software may be employed. In such a case, the color correction apparatus 70 includes a CPU, a main storage device, such as a RAM, and a computer-readable recording medium that stores a program for carrying out all or part of the processes described above. Accordingly, the same processes are carried out by the color correction apparatus 70 by reading out the program stored on the storage medium by the CPU and carrying out information processing and computation.

Here, a computer-readable recording medium is a magnetic disk, a magneto-optical disk, a CD-ROM, a DVD-ROM, or a semiconductor memory. A computer program may be delivered to a computer via a communication line, and the computer that receives the delivered program may execute the program.

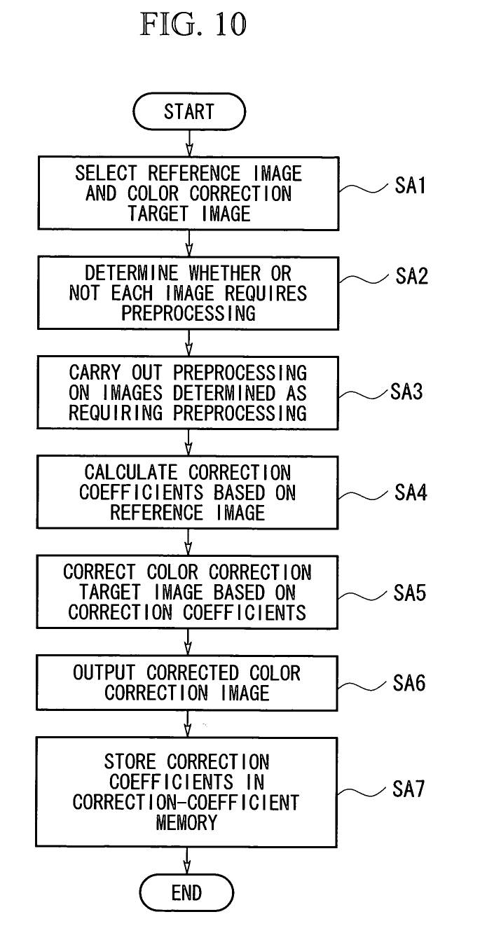

The steps of a color correction method carried out by the CPU executing a color correction program will be described with reference to FIG. 10.

First, as shown in Step SA1 in FIG. 10, a reference image is selected from the reference-image storage unit 3, and a color correction target image is selected from the color-correction-target-image storage unit 4. In Step SA2, it is determined whether these images require preprocessing. As a result, when it is determined that preprocessing is required, in Step SA3, an LUT suitable for the image requiring preprocessing is used to carry out preprocessing, and the image is returned to that before color adjustment was carried out. In this way, a reference image and the color correction target image that are not color-adjusted are obtained. Then, in Step SA4, correction coefficients of the color correction target image are calculated on the basis of the reference image. In Step SA5, color correction processing is carried out on all pixels in the color correction target image on the basis of the calculation results. Subsequently, in Step SA6, the color-corrected color correction target image is output. Finally, in Step SA7, the correction coefficients are stored in a correction coefficient memory, and then the process is completed.

What is claimed is:

1. A color correction apparatus comprising:
a determining unit configured to determine whether or not preprocessing for removing the effect of previously-performed color adjustment is required for a reference image that is used for a reference of color adjustment and a color correction target image on which color correction is to be carried out;
a preprocessing unit configured to carry out preprocessing on the reference image and color correction target image that are determined by the determining unit as requiring preprocessing and to output preprocessed images; and
a color-correction processing unit configured to acquire a reference image or color correction target image that is not preprocessed if the determining unit determines that the reference image or color correction target image does not require preprocessing or to acquire a preprocessed reference image or color correction target image if the determining unit determines that the reference image or color correction target image requires preprocessing, and to correct the color correction target image on the basis of the acquired reference image.

2. The color correction apparatus according to claim 1, wherein the preprocessing includes gradation restoration for restoring the effect of gradation correction that has been previously performed on an input reference image or color correction target image.

3. The color correction apparatus according to claim 1, wherein the preprocessing includes γ-correction for restoring the effect of inverse γ-correction that has been previously performed on an input reference image or color correction target image.

4. The color correction apparatus according to claim 1, further comprising:
an input unit configured to receive an input from an external unit concerning whether or not the preprocessing is required,
wherein the determining unit carries out a determination process on the basis of information received from the input unit.

5. The color correction apparatus according to claim 1, wherein the determining unit carries out a determination process on the basis of at least one of a file name and attribute information of the reference image and color correction target image.

6. The color correction apparatus according to claim 1, wherein the reference image comprises spectral image data corresponding to more than four spectral bands.

7. The color correction apparatus according to claim 1, wherein the preprocessing unit includes
an estimating unit configured to estimate the type of the input apparatus used for inputting the reference image or the color correction target image,
a storage unit configured to store, in association with the input apparatus, parameters used for the preprocessing
a parameter-acquiring unit configured to acquire parameters corresponding to the input apparatus estimated by the estimating unit, and
a processing unit configured to carry out the preprocessing on the input reference image or color correction target image using the parameters acquired by the parameter-acquiring unit.

8. The color correction apparatus according to claim 1, further comprising:
a reference-image storage unit configured to store a plurality of reference images;
a reference-image selecting unit configured to select a reference image that satisfies a predetermined condition from the reference-image storage unit; and
a reference-image acquiring unit configured to acquire a reference image selected by the reference-image selecting unit from the reference-image storage unit,
wherein the color-correction processing unit corrects the color correction target image using a reference image acquired by the reference-image acquiring unit.

9. The color correction apparatus according to claim 8, wherein the reference-image storage unit is provided on a file server connected via a network.

10. The color correction apparatus according to claim 8, further comprising:
a color-correction-target-image analyzing unit configured to analyze the color correction target image,
wherein the reference-image selecting unit selects a reference image in accordance with the analysis result of the color-correction-target-image analyzing unit.

11. The color correction apparatus according to claim 8, further comprising:
an image-acquisition information input unit configured to input information related to at least one of an object and an image-acquisition condition of the color correction target image,
wherein the reference-image selecting unit selects a reference image in accordance with the information input from the image-acquisition information input unit.

12. The color correction apparatus according to claim 8, further comprising:
a candidate-presenting unit configured to present a plurality of reference images selected by the reference-image selecting unit to the user as reference image candidates; and
a reference-image determining unit configured to select a reference image to be actually used from the reference image candidates presented by the candidate-presenting unit,
wherein the plurality of reference images is selected by the reference-image selecting unit as reference images.

13. A method of color correction comprising:
a determining step of determining whether or not preprocessing for removing the effect of previously-performed color adjustment is required for a reference image that is used as a reference of color adjustment and a color correction target image on which color correction is to be carried out;
a preprocessing step of carrying out preprocessing on the reference image and color correction target image that are determined as requiring preprocessing and outputting preprocessed images; and
a color correction step of acquiring a reference image or color correction target image that is not preprocessed if the determining unit determines that the reference image or color correction target image does not require preprocessing or acquiring a preprocessed reference image or color correction target image if the determining unit determines that the reference image or color correction target image requires preprocessing, and correcting the color correction target image on the basis of the acquired reference image.

14. The method of color correction according to claim 13, further comprising:
a reference-image storing step of storing a plurality of reference images;
a reference-image selecting step of selecting a reference image that satisfies a predetermined condition from the plurality of reference images stored in the reference-image storing step; and
a reference-image acquiring step of acquiring the selected reference image,
wherein, in the color correction step, the color correction target image is corrected using the reference image acquired in the reference-image acquiring step, and
wherein, in the reference-image acquiring step, the reference image is acquired via a network.

15. A color correction program to be executed by a computer, the program comprising:
a determining step of determining whether or not preprocessing for removing the effect of previously-performed color adjustment is required for a reference image that is used as a reference of color adjustment and a color correction target image on which color correction is to be carried out;
a preprocessing step of carrying out preprocessing on the reference image and color correction target image that are determined as requiring preprocessing and outputting preprocessed images; and
a color correction step of acquiring a reference image or color correction target image that is not preprocessed if the determining unit determines that the reference image or color correction target image does not require preprocessing or acquiring a preprocessed reference image or color correction target image if the determining unit determines that the reference image or color correction target image requires preprocessing, and correcting the color correction target image on the basis of the acquired reference image.

16. The color correction program according to claim 15, further comprising:
a reference-image storing step of storing a plurality of reference images;
a reference-image selecting step of selecting a reference image that satisfies a predetermined condition from the plurality of reference images stored in the reference-image storing step; and
a reference-image acquiring step of acquiring the selected reference image,
wherein, in the color correction step, the color correction target image is corrected using the reference image acquired in the reference-image acquiring step, and
wherein, in the reference-image acquiring step, the reference image is acquired via a network.
